(19) United States
(12) Patent Application Publication
(10) Pub. No.: US 2006/0089163 A1
(43) Pub. Date: Apr. 27, 2006

(54) Method and system for delivering messages

(76) Inventors: Jean Khawand, Miami, FL (US); Alif M. Khawand, Miami, FL (US)

Correspondence Address: Larry G. Brown;Motorola, Inc., Law Department, 8000 West Sunrise Boulevard, Fort Lauderdale, FL, 33322, US

(21) Appl. No.: 10/971,190

(22) Filed: Oct. 22, 2004

(51) Int. Cl. H04Q 7/20

(52) U.S. Cl. 455/466; 455/456.1

(57) ABSTRACT

The invention concerns a method (300) and system (100) for delivering messages. The method can include the steps of receiving (314) a message from a sender, selectively storing (316) the message from the sender and notifying (322) a user of a target portable electronic device (134) of the message when the target portable electronic device reaches a predetermined geographic location. The method can also include the step of tracking (312) the target portable electronic device with a positional tracking unit (218). The selectively storing step can include storing (318) the message in at least one of a communications network component (118, 126) or a storage unit (212) in the target portable electronic device.

### BACKGROUND OF THE INVENTION

1. Field of the Invention

This invention relates in general to delivering messages and more particularly to delivering messages to portable electronic devices.

2. Description of the Related Art

In recent years, portable electronic devices, such as cellular telephones and personal digital assistants, have become commonplace. These devices allow users to keep in contact with others concerning business or personal issues. In particular, there are myriad ways in which someone may relay a message to a user of such a device. For example, a person can directly speak with the user, leave a voicemail for the user or generate an e-mail or text message for the user. In one specific example, a person may contact a user of a portable electronic device through any of the methods recited above to remind the user of some important information, such as an appointment or other obligation. Unfortunately, the user of the device may not wish to be disturbed for certain reasons. For example, the user may be in an important meeting or may be operating an automobile.

### SUMMARY OF THE INVENTION

The present invention concerns a method for delivering messages. The method can include the steps of receiving a message from a sender, selectively storing the message from the sender and when a target portable electronic device of the message reaches a predetermined geographic location, notifying a user of the target portable electronic device of the message. The method can also include the step of tracking the target portable electronic device with a positional tracking unit. In addition, the selectively storing step can include storing the message in a communications network component or the target portable electronic device. In one arrangement, the message can be a voicemail, an e-mail, a text message, an instant message or a private call alert.

The method can further include the step of notifying the user of the target portable electronic device of the message at a predetermined time when the user is in the predetermined geographic location. Also, the portable electronic device can be a cellular telephone, a personal digital assistant, a two-way radio or a messaging device.

The present invention also concerns a portable electronic device for delivering messages. The portable electronic device can include a receiving unit for receiving a message from a sender, a user interface section and a processor coupled to the receiving unit and the user interface section. In one arrangement, the processor can notify a user of the message through the user interface section when the portable electronic device enters a predetermined geographic location. The portable electronic device can also include suitable software and/or circuitry to carry out the processes described above.

The present invention also concerns a system for delivering messages. The system can include a communications network and a mobile communications unit that operates on the communications network. The mobile communications unit can have a receiving unit for receiving a message from the communications network, a user interface section and a processor coupled to the receiving section and the user interface section. The processor can notify a user of the message through the user interface section when the mobile communications unit enters a predetermined geographic location. The system can also include suitable software and/or circuitry to carry out the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for delivering messages in accordance with an embodiment of the inventive arrangements;

FIG. 2 illustrates an example of a block diagram of a portable electronic device that can be used in the system of FIG. 1 in accordance with an embodiment of the inventive arrangements; and

FIG. 3 illustrates a method for delivering messages in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

This invention presents a method and system for delivering messages. In one arrangement, the method can include the steps of receiving a message from a sender, selectively storing the message from the sender and notifying a user of a target portable electronic device of the message when the target portable electronic device reaches a predetermined geographic location. The method can also include the step of tracking the target portable electronic device with a positional tracking unit. As an example, the message can be selectively stored in a component of a communications network or in a storage unit of the target portable electronic device. In addition, the user of the target portable electronic device can be notified at a predetermined time when the user is in the predetermined geographic location.

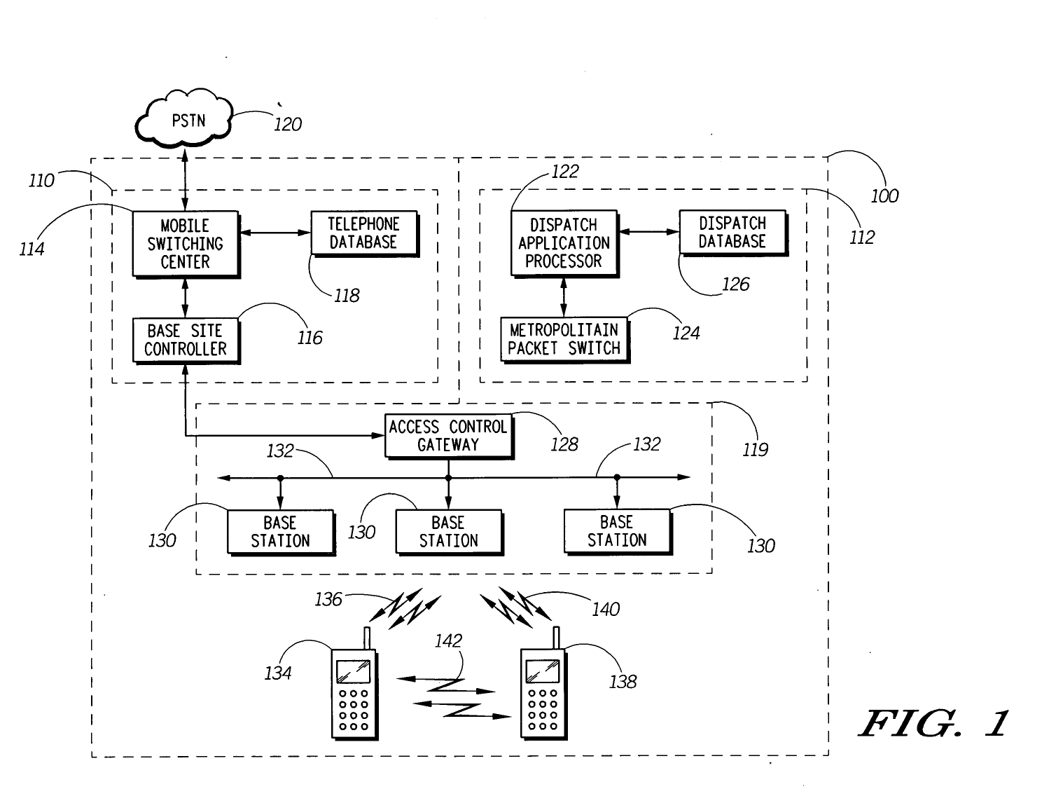

Referring to FIG. 1, a system 100 for delivering messages is shown. As an example and without limitation, the system 100 can include both a cellular telephone services portion 110 for supporting cellular telephone services and a trunked dispatch services portion 112 for supporting trunked dispatch services. To support the cellular telephone services, the cellular telephone services portion 110 can include a mobile switching center (MSC) 114, a base site controller (BSC) 116 and a telephone database 118. The MSC 114 can be coupled to the public switched telephone network (PSTN) 120, the BSC 116 and the telephone database 118, which may also be referred to as a storage unit of the communications network 100. The BSC 116 can be coupled to at least one site 119, which, as will be described below, can include infrastructure that supports wireless communications.

To support the dispatch services, the trunked dispatch services portion 112 can include a dispatch application processor (DAP) 122, a metropolitan packet switch (MPS) 124 and a dispatch database 126, which may also be referred to as a storage unit of the communications network 100. The DAP 122 can be coupled to the MPS 124 and the dispatch database 126. The MPS 124 can also be coupled to the site 119. As such, both the cellular telephone services portion 110 and the trunked dispatch services portion 112 can share the infrastructure of the site 119 for processing both the cellular telephone and dispatch services. Although such a shared configuration is efficient, it is not necessary for the operation of either of these services. In addition, it is understood that the cellular telephone services portion 110 and the trunked dispatch services portion 112 can be coupled to sites other than or in addition to site 119.

In one arrangement, the site 119 can include one or more access control gateways 128, one or more base stations 130 and one or more buses 132 for coupling the base stations 130 to the access control gateway 128. The base stations 130 can communicate with, for example, a portable electronic device 134 over a wireless communications link 136 and with, as another example, an electronic device 138 over another wireless communications link 140. The portable electronic device 134 and the electronic device 138 can also communicate with one another over another wireless communications link 142 without the assistance of a communications network.

In one arrangement, the portable electronic device 134 can be any electronic unit that is capable of receiving messages and capable of being transported by a user over various geographic locations. As an example, the portable electronic device 134 can be a mobile communications unit, such as a cellular telephone, a personal digital assistant (PDA), a two-way radio, a messaging device, a laptop computer, etc. The electronic device 138 can be any electronic component capable of transmitting a message to the first portable electronic device 134. As an example, the electronic device 138 can also be a mobile communications unit, like a cellular telephone, a PDA, a two-way radio, a messaging device, a laptop computer, etc. The electronic device 138 can also be, for example, a hard-wired computing device that can transmit messages to the portable electronic device 134.

The access control gateway 128 can include a computational platform having computational capacity and storage sufficient to support the functions described below. In addition, the link between the access control gateway 128 and the cellular telephone services portion 110 can be any high-level data link, as defined by the International Standards Organization. In one arrangement, the link between the access control gateway 128 and the trunked dispatch services portion 112 can be a frame relay link. It is understood, however, that the invention is not limited in this regard, as any other suitable link can be used between the access control gateway 128 and the services portions 110,112.

The base stations 130 can include radio transceivers configured to receive and transmit on appropriate frequencies using suitable modulation and air interface protocols for supporting the requirements of the services being provided. In another arrangement, the bus 132 that couples the base stations 130 to the access control gateway 128 can be an Ethernet link, as is well understood in the art.

The operation and configuration of the cellular telephone services portion 110 and the trucked dispatch services portion 112 are well known, and an in-depth discussion is not warranted. Briefly, however, the MSC 114 can interface with the PSTN 116 and the BSC 116. The MSC 114 can also control the provision of cellular telephone service to, for example, the portable electronic device 134 and the electronic device 138, if the portable electronic device 134 and the electronic device 138 support such a service.

The telephone database 118 can provide to the MSC 114 information concerning the operation of communications units, such as the portable electronic device 134 and the electronic device 138. Examples of this information can include present site location, present telephone call activity, billing information and roaming status. In one particular arrangement, messages that are intended to be transmitted to the portable electronic device 134 or the electronic device 138 can be selectively stored in the telephone database 118.

Turning to the trunked dispatch services portion 112, the DAP 122 can be programmed to allocate communication resources among dispatch service users. The DAP 122 can also alert all members of a dispatch group that a dispatch call is imminently (or presently) underway, which can permit the members of the group to participate in the call. As those of ordinary skill in the art will appreciate, the MPS 124 can route audio signals between sites 119 to facilitate the inclusion of other participating call members who are located in other sites that the trunked dispatch services portion 112 serves.

The dispatch database 126 can include information that relates to the operability status of, for example, the portable electronic device 134 and the electronic device 138, although the dispatch database 126 can include information relating to the operability status of any suitable number of communications units. As an example and without limitation, the information stored by the dispatch database 126 can include individual identification, group identification, alias information, roaming status and priority information. Similar to the telephone database 118, the dispatch database 126 can also selectively store messages that are intended to be transmitted to the portable electronic device 134 or the electronic device 138.

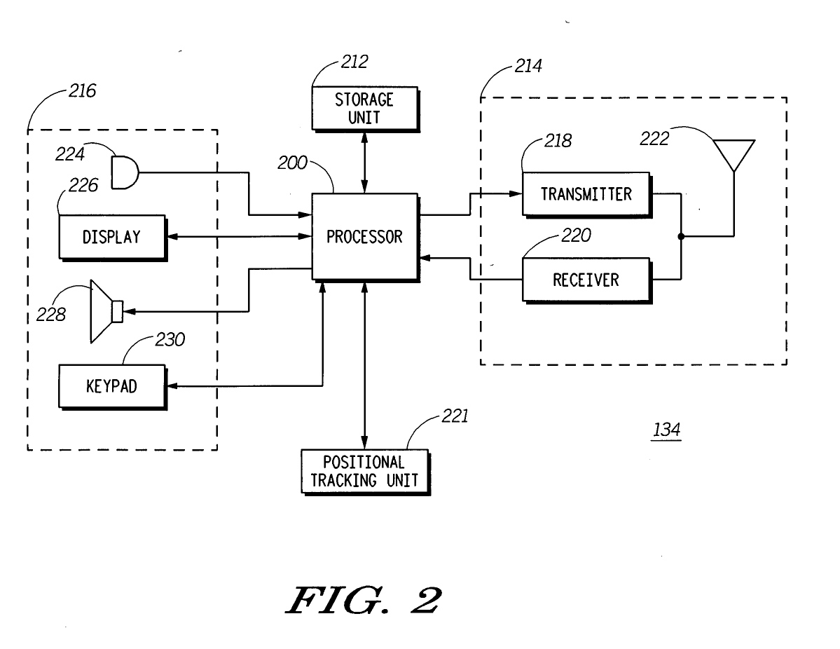

Referring to FIG. 2, a block diagram of an example of a portable electronic device 134 is shown. The electronic device 138 may also include at least some of the components shown in FIG. 2. In one arrangement, the portable electronic device 134 can include a processor 200, a storage unit 212, a receiving section 214, a user interface section 216 and a positional tracking unit 221. The processor 200 can be coupled to and control the operation of the storage unit 212, the receiving section 214, the user interface section 216 and the positional tracking unit 221.

The storage unit 212 can be any suitable form of memory that can selectively store messages received from the communications network 100 or directly from the electronic device 138. The processor 200, as will be explained later, can retrieve one or more messages from the storage unit 212 based on certain parameters, such as the location of the portable electronic device 134 or a predetermined time.

The receiving section 214 can include a transmitter 218, a receiver 220 and an antenna 222, which can be coupled to both the transmitter 218 and the receiver 220. Through the transmitter 218, the receiver 220 and the antenna 222, the portable electronic device 134 can transmit and receive wireless communications signals—such as voice and/or data signals—in a manner well known to those of skill in the art. For example, the receiver 220 can receive signals from the antenna 222 and can convert and demodulate these signals for further processing. When the portable electronic device 134 is transmitting signals, the transmitter 218 can transmit communications signals though the antenna 222. Of course, the receiving section 214 can be configured in any other suitable fashion.

In another arrangement, the user interface section 216 may include a microphone 224, a display 226, a speaker 228 and a keypad 230, each of which can be coupled to the processor 200. The microphone 224 can receive audio signals and can transfer them to the processor 200 for further processing. Additionally, the display 226 can display to a user any suitable type of imagery. In one embodiment, the display 226 can be a touch-screen display for accepting user input, if the display 226 has suitable software and circuitry for doing so. The speaker 228 can broadcast audio, and as an example, both the display 226 and the speaker 228 can notify a user of a message that has been received by the portable electronic device 134.

The positional tracking unit 221 can monitor the geographical positioning of the portable electronic device 134 and can signal the processor 200 with this data. As an example, the positional tracking unit 221 can be a global positioning system (GPS) tracker or receiver that can track the positioning of the portable electronic device 134 using trilateration principles that are well known in the art. Another example would be for the location of the portable electronic device 134, if it is a mobile communications unit, to be coarsely determined by the location area in which the portable electronic device 134 is registered. As the portable electronic device 134 moves from one location area to another, its position can be determined by the communications network 100. The communications network 110 can then relay the position of the portable electronic device 134 back to the device 134. Of course, any other suitable method for determining the position of the portable electronic device 134 can be implemented.

Although an example of a communications network and an example of a portable electronic device have been described, it is understood that the invention is not so limited. In particular, the communications network 100 is not restricted to supporting cellular telephone or dispatch services (or both), as the communications network 100 can be configured to facilitate communications over any other suitable network using any suitable transmission protocol. In addition, any other suitable portable electronic devices can be used with the communications network 100 or any other suitable communications network.

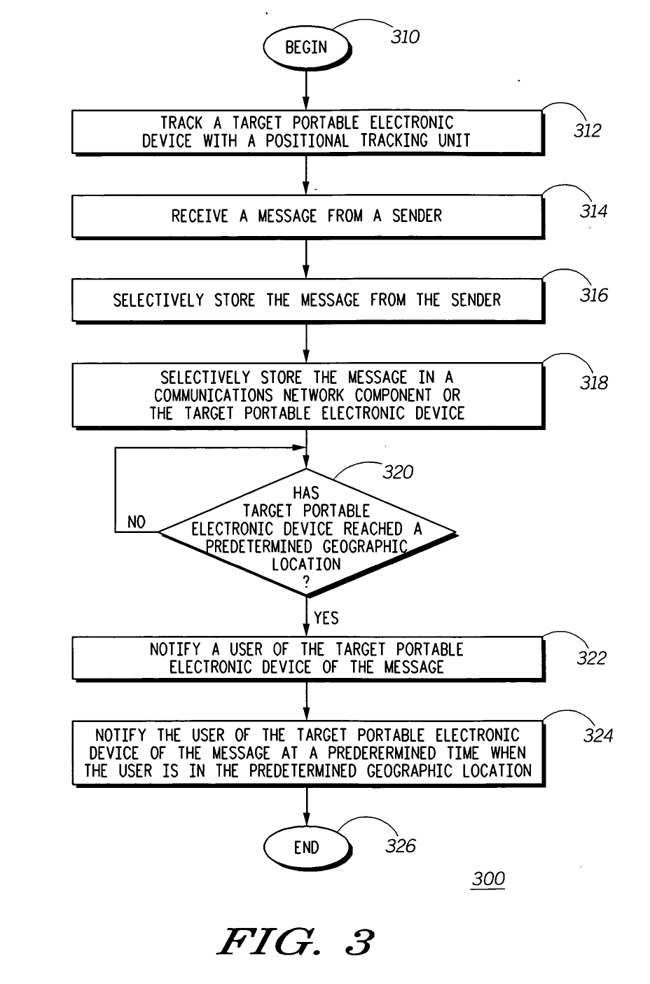

Referring to FIG. 3, a method 300 for delivering messages is shown. To describe the method 300, reference may be made to FIGS. 1 and 2, although the method 300 can be practiced in other situations using any other suitable devices or systems. Moreover, the method 300 is not limited to the particular steps that are shown in FIG. 3 or to the order in which they are depicted. The inventive method 300 may also include a fewer number of steps as compared to what is shown in FIG. 3.

At step 310, the method 300 can begin. At step 312, a target portable electronic device can be tracked with a positional tracking unit. At step 314, a message can be received from a sender, and the message from the sender can be selectively stored, as shown at step 316. As an example, at step 318, the message can be selectively stored in a communications network component or the target portable electronic device.

For example, referring to FIGS. 1 and 2, the positional tracking unit 221 of the portable electronic device 134 can continuously determine the location of the portable electronic device 134. As explained earlier, the positional tracking unit 221 can be a GPS tracker or receiver that can relay to the processor 200 positional information concerning the portable electronic device 134.

Continuing with the example, the portable electronic device 134 or the communications network 100 can receive a message from a sender. For example, a user of the electronic device 138 may wish to send one or more messages to a user of the portable electronic device 134. As such, the portable electronic device 134 may be referred to as a target portable electronic device. As an example, the message can be a voicemail, an e-mail, a text message, an instant message, a private call alert or any other suitable combination of data recognizable by a user for purposes of providing the user with information. For purposes of the invention, the term sender can include human beings as well as machines capable of generating messages.

The message from the sender can be received at, for example, the cellular telephone services portion 110 or the trunked dispatch services portion 112 of the communications network 100. In one arrangement, the message can be stored in the telephone database 118 or the dispatch database 126 for later retrieval. Alternatively, the cellular telephone services portion 110 or the trunked dispatch services portion 112 can forward the message to the target portable electronics device 134. In this example, the receiver 220 of the receiving unit 214 can receive and process the incoming message. The processor 200 can then direct the message to the storage unit 212 for later retrieval.

Referring back to the method 300 of FIG. 3, at decision block 320, it can be determined whether the target portable electronic device has reached a predetermined geographic location. If the target portable electronic device has not yet reached the predetermined geographic location, the method 300 can resume at the decision block 320. If it has, however, the method 300 can continue at step 322. At step 322, a user of the target portable electronic device can be notified of the message. In addition, at step 324, the user of the target portable electronic device can be notified of the message at a predetermined time when the user is in the predetermined geographic location. The method 300 can then end at step 326.

For example, referring once again to FIGS. 1 and 2, when the sender of the message transmits the message, the sender can restrict the delivery of the message to a geographic location of the target portable electronic device 134. In particular, through any suitable user interface of the electronic device 138, the sender can specify that the message can only be sent when the target portable electronic device 134 enters a predetermined geographic location.

For instance, the sender may send a text message to a user of the target portable electronic device 134 reminding the user to purchase several items at a retail establishment. The sender may enter the address of the retail establishment (or select it from a menu) in the electronic device 138 and restrict the delivery of the text message to when the user of the target portable electronic device 134 reaches the retail establishment, or at least comes within a certain distance of the establishment. The appropriate component can be made aware of this predetermined geographical location, such as the MSC 114, the DAP 122 or the processor 200.

If the message is delivered to the communications network 100 for storage, the target portable electronic device 134 can periodically signal its location to the communications network 100. For example, the processor 200 of the target portable electronic device 134 can obtain the positional information from the positional tracking unit 221. The processor 200 can then signal the transmitter 218 of the receiving unit 214 to transmit the positional information to the appropriate base station 130. From the base station 130, the positional information can be routed to the MSC 114 or the DAP 122 through the access control gateway 128.

If the MSC 114 or the DAP 122 determines that the target portable electronic device 134 has entered the predetermined geographic location, the MSC 114 or the DAP 122 can access the message from the telephone database 118 or the dispatch database 126, respectively. The MSC 114 or the DAP 126 can then cause the message to be sent to the target portable electronic device 134. Once received, the processor 200 can cause the user to be notified of the message by signaling one or more components of the user interface section 216. For example, the processor 200 can signal the display 226 to display the message and/or signal the speaker 228 to broadcast an audio version message.

As an alternative, the message may be delivered to the target portable electronic device 134 for storage. In this case, the receiver 220 can receive and process the message, and the processor 200 can transfer the message to the storage unit 212. As noted earlier, the processor 200 can periodically receive positional information from the positional tracking unit 221. When the processor 200 determines that the target portable electronic device 134 has reached the predetermined geographic location, the processor 200 can retrieve the message from the storage unit 212. Similar to the above example, the processor 200 can signal the appropriate component of the user interface section 216, such as the display 226 or the speaker 228, to inform the user of the message.

In accordance with another embodiment, the sender of the message may also incorporate a temporal restriction on the delivery of the message. For example, the sender may wish to have the message delivered to the user of the target portable electronic device 134 a predetermined amount of time after the device 134 has entered the predetermined geographical location. As another example, the message can be delivered to the user at a specific time if the target portable electronic device 134 is in the predetermined geographical location. For example, the sender can program the message to be delivered to the user ten minutes after the target portable electronic device 134 enters the predetermined geographical location or at a particular time of day if the device 134 is in the predetermined location.

In another arrangement, the sender can program the message to be sent to the user of the target portable electronic device 134 based on a temporal restriction only. Specifically, the message can be programmed to be delivered to the user at a particular date and time, regardless of the location of the target portable electronic device 134. In another embodiment, the storage of the message may not be necessary if it is determined that the target portable electronic device 134 is already positioned within the predetermined geographical location when the message is sent. In addition, if the target portable electronic device 134 and the electronic device 138 communicate with one another without the assistance of a communications network, the message may be stored in the storage unit 212 of the target portable electronic device 134.

The message may also be eventually delivered even if the user of the portable electronic device 134 does not enter the predetermined geographical location. For example, if the message is to be stored in the communications network 100, the appropriate unit of the communications network 100 can forward the message to the portable electronic device 134 after a predetermined temporal period. The user can be made aware of the message through the user interface section 216 in accordance with the previous discussion. This delivery can occur even if the user of the portable electronic device 134 fails to enter the predetermined geographic location. A similar time-out process can occur if the message is stored in the portable electronic device 134.

The present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for delivering messages, comprising the steps of:
receiving a message from a sender;
selectively storing the message from the sender;
when a target portable electronic device of the message reaches a predetermined geographic location, notifying a user of the target portable electronic device of the message.

2. The method according to claim 1, further comprising the step of tracking the target portable electronic device with a positional tracking unit.

3. The method according to claim 1, wherein the selectively storing step comprises storing the message in at least one of a communications network component and the target portable electronic device.

4. The method according to claim 1, wherein the message is at least one of a voicemail, an e-mail, a text message, an instant message and a private call alert.

5. The method according to claim 1, further comprising the step of notifying the user of the target portable electronic device of the message at a predetermined time when the user is in the predetermined geographic location.

6. The method according to claim 1, wherein the portable electronic device is at least one of a cellular telephone, a personal digital assistant, a two-way radio and a messaging device.

7. A portable electronic device for delivering messages, comprising:
a receiving unit for receiving a message from a sender;
a user interface section; and
a processor coupled to the receiving unit and the user interface section, wherein the processor notifies a user of the message through the user interface section when the portable electronic device enters a predetermined geographic location.

8. The portable electronic device according to claim 7, further comprising a positional tracking unit coupled to the processor, wherein the positional tracking unit monitors the geographical position of the portable electronic device.

9. The portable electronic device according to claim 7, further comprising a storage unit, wherein the storage unit selectively stores the received message.

10. The portable electronic device according to claim 7, wherein the message is selectively stored in a component of a communications network.

11. The portable electronic device according to claim 7, wherein the message is at least one of a voicemail, an e-mail, a text message, an instant message and a private call alert.

12. The portable electronic device according to claim 7, wherein the processor is further programmed to notify the user of the target portable electronic device of the message at a predetermined time when the user is in the predetermined geographic location.

13. The portable electronic device according to claim 7, wherein the portable electronic device is at least one of a cellular telephone, a personal digital assistant, a two-way radio and a messaging device.

14. A system for delivering messages, comprising:
a communications network; and
a mobile communications unit that operates on the communications network;
wherein the mobile communications unit has a receiving unit for receiving a message from the communications network, a user interface section and a processor coupled to the receiving section and the user interface section;
wherein the processor notifies a user of the message through the user interface section when the mobile communications unit enters a predetermined geographic location.

15. The system according to claim 14, wherein the mobile communications unit further comprises a positional tracking unit coupled to the processor, wherein the positional tracking unit monitors the geographical position of the mobile communications unit.

16. The system according to claim 14, wherein the communications network comprises a storage unit and the mobile communications unit further comprises a storage unit, wherein at least one of the storage unit of the communications network and the storage unit of the mobile communications unit selectively stores the message.

17. The system according to claim 14, wherein the processor of the mobile communications unit is further programmed to notify the user of the mobile communications unit of the message at a predetermined time when the user is in the predetermined geographic location.
